(19) United States
(12) Patent Application Publication
(10) Pub. No.: US 2015/0151537 A1
(43) Pub. Date: Jun. 4, 2015

(54) INK JET RECORDING APPARATUS

(71) Applicant: MIMAKI ENGINEERING CO., LTD., NAGANO (JP)

(72) Inventors: Masaru Ohnishi, Nagano (JP); Tomomi Igawa, Nagano (JP)

(21) Appl. No.: 14/406,754

(22) PCT Filed: Jun. 19, 2013
(86) PCT No.: PCT/JP2013/066801

§ 371 Date: Dec. 10, 2014

(30) Foreign Application Priority Data
Jun. 21, 2012 (JP) 2012-140171

(51) Int. Cl. B41J 2/14

(52) U.S. Cl. CPC B41J 2/14

(57) ABSTRACT

To provide an inkjet recording apparatus which is compact and is configured to reduce a volatile organic compound generated at the time of printing. As a solving means, an inkjet recording apparatus 100 is the inkjet recording apparatus 100 including a head 1 configured to eject the ink containing the volatile organic compound onto a medium 20, and configured to perform printing on the medium 20 by moving the positions of the head and the medium 20, and includes a decomposition device 4 configured to at least decompose the volatile organic compound in the mist ink generated when the ink is ejected from the heads 1.

### TECHNICAL FIELD

The present invention relates to an inkjet recording apparatus configured to decompose a volatile organic compound (VOC).

### BACKGROUND ART

PTL 1 discloses a dryer for a printing apparatus configured to deodorize exhaust gas used for drying ink on printed material with a dryer body through a combustion-type deodorizer and then discharge the exhaust gas to atmosphere.

### CITATION LIST

### Patent Literature

PTL 1: JP-A-11-291454 (published Oct. 26, 1999)

### SUMMARY OF INVENTION

### Technical Problem

An apparatus configured to burn a volatile organic compound that volatilizes by drying printing paper and dry the printing paper by generated heat is known in the related art. However, as described in PTL 1, the apparatus may be increased in size as an entire printing apparatus including deodorizing means such that accessories such as a heat storage member need to be provided in addition to a cavity configured to cover the printing paper, and also a space for piping is required.

In view of such a problem as described above, it is an object of the present invention to provide an inkjet recording apparatus which is compact and is configured to reduce a volatile organic compound generated at the time of printing.

### Solution to Problem

In order to solve the above-described problem, an inkjet recording apparatus of the present invention is an inkjet recording apparatus including a head configured to eject ink containing a volatile organic compound onto a recording medium, and being configured to perform printing on the recording medium by relatively moving positions of the head and the recording medium, characterized by providing a decomposition means configured to at least decompose the volatile organic compound in the mist ink generated when the ink is ejected from the head.

Since the ink contains the volatile organic compound, if the ink is ejected from the head onto the recording medium, the volatile organic compound volatilizes. Also, when the ink is ejected from the head, the mist ink containing the volatile organic compound is generated. Here, the decomposition means decomposes the volatile organic compound in the mist ink generated when the ink is ejected from the head in addition to the volatile organic compound which volatilizes from the ink ejected onto the recording medium. Therefore, the volatile organic compound with high concentration before the volatile organic compound is dispersed widely within the inkjet recording apparatus can be collected and efficiently decomposed. Therefore, processing of a large amount of air in the inkjet recording apparatus is not necessary, and less electric power consumed when decomposing the volatile organic compound may be required.

The decomposition means is located so as to be capable of decomposing a volatile substance in the mist ink generated when the ink is ejected, and hence is located in the vicinity of the head. Therefore, the apparatus may be configured to have a compact profile.

Preferably, the inkjet recording apparatus of the present invention includes a carriage having the head, and the carriage is configured to sweep on the recording medium, and is provided with the decomposition means.

Since the carriage configured to sweep on the recording medium has the decomposition means configured to decompose the volatile organic compound, the volatile organic compound with high concentration before the volatile organic compound is dispersed widely within the inkjet recording apparatus can be collected and efficiently decomposed.

Since the carriage is provided with the decomposition means, the inkjet recording apparatus can be configured to have a further compact profile.

Preferably, in the inkjet recording apparatus of the present invention, the carriage further includes an adsorption means configured to adsorb the mist ink generated when the ink is ejected from the head, and the adsorption means is passed through the volatile organic compound and the mist ink, and then the decomposition means decomposes the volatile organic compound.

When the volatile organic compound contained in the ink is volatilized, the volatilized compound is mixed with the mist ink generated when the ink is ejected from the head within the inkjet recording apparatus. When the adsorption means is passed through the mixture, the mist ink is adsorbed. Therefore, only the volatile organic compound can be introduced into the decomposition means, and hence lowering of decomposition function of the decomposition means due to the introduction of the mist ink into the decomposition means is prevented.

In the case where an airflow generating apparatus is provided, the airflow generating apparatus can be commonly used for collection of the mist ink by the adsorption means and introduction of the volatile organic compound to the decomposition means, so that the inkjet recording apparatus can be configured to have a further compact profile.

Preferably, in the inkjet recording apparatus of the present invention, the head is fixed, and is configured to move the recording medium to perform printing on the recording medium, and the decomposition means is provided on the side where the recording medium after printing is moved when viewed from the head.

After printing on the recording medium has terminated, the recording medium is moved to the side where the decomposition means is provided. Then, the decomposition means is allowed to collect and decompose the volatile organic compound vaporized from the recording medium after the printing efficiently.

Preferably, in the inkjet recording apparatus of the present invention, the decomposition means includes a suction port configured to suck the volatile organic compound and the mist ink, the suction port includes an adsorption means configured to adsorb the mist ink, and the adsorption means is passed through the volatile organic compound and the mist ink, and then the decomposition means decomposes the volatile organic compound.

When the volatile organic compound contained in the ink is volatilized, the volatilized compound is mixed with the mist ink generated when the ink is ejected from the head within the inkjet recording apparatus. Then, when the mixture is sucked into the interior of the suction port and the adsorption means is passed through the mixture, the mist ink is adsorbed. Therefore, only the volatile organic compound can be introduced into the decomposition means, and hence lowering of decomposition function of the decomposition means due to the introduction of the mist ink into the decomposition means is prevented.

Preferably, in the inkjet recording apparatus of the present invention, the decomposition means includes an introduction port configured to introduce the volatile organic compound, and a discharging port configured to discharge the exhaust gas having heat generating when the volatile organic compound is decomposed, and the recording medium is dried by blowing the exhaust gas exhausted from the discharging port to the recording medium.

By decomposing the volatile organic compound, the exhaust gas having heat is generated. The exhaust gas is discharged from the decomposition means via the discharging port, and is blown to the recording medium. Accordingly, the exhaust gas having heat is blown to the recording medium, and the recording medium can be efficiently dried.

Preferably, in the inkjet recording apparatus of the present invention, the decomposition means includes a decomposition unit configured to decompose the volatile organic compound and generate the exhaust gas, and a heat exchanging unit configured to introduce the volatile organic compound to the decomposition unit and introduce the exhaust gas from the decomposition unit to the discharging port, and the heat exchanging unit supplies heat from the exhaust gas to the volatile organic compound.

In the heat exchanging unit, the exhaust gas has heat generating when the volatile organic compound is decomposed, and supplies the heat from the exhaust gas to a gas containing the volatile organic compound (for example, a mixed gas of volatile organic compound and air). Then, the gas containing the volatile organic compound to which the heat is supplied is introduced to the decomposition unit, lowering of the temperature in the decomposition unit is restrained.

Preferably, in the inkjet recording apparatus according to the present invention, the decomposition means includes an introduction tube for introducing the volatile organic compound to the decomposition unit from the introduction port, and the introduction tube is provided further outside than the decomposition unit and the heat exchanging unit.

Since the introduction tube is provided further outside than the decomposition unit and the heat exchanging unit, heat generating when the volatile organic compound is decomposed can be absorbed by the gas containing the volatile organic compound which passes through the introduction tube. Also, transfer of the heat generating in the decomposition unit and the heat exchanging unit to the carriage is further restrained, and hence damage of the carriage by the heat can be restrained.

Preferably, in the inkjet recording apparatus of the present invention, the decomposition means decomposes the volatile organic compound by oxidation decomposition processing method.

By employing the oxidation decomposition processing method, the inkjet recording apparatus can be formed into a compact profile, and a stable volatile organic compound removal performance can be maintained for a long term in comparison with other decomposition methods. Specific examples of the oxidation decomposition processing method include a catalytic system, a direct burning system and the like using a burner, a heating wire, or the like.

### Advantageous Effects of Invention

The present invention has an advantageous effect that the inkjet recording apparatus which is compact and is configured to reduce a volatile organic compound generated at the time of printing is provided.

### BRIEF DESCRIPTION OF DRAWINGS

FIG. 1 is a drawing of an inkjet recording apparatus according to an embodiment of the present invention.

FIG. 2 is a drawing illustrating a decomposition means provided in the inkjet recording apparatus according to an embodiment of the present invention.

FIG. 3 is a drawing illustrating the inkjet recording apparatus according to an embodiment of the present invention.

FIG. 4 is a drawing illustrating an inkjet recording apparatus according to another embodiment of the present invention.

FIG. 5 is a top view illustrating the inkjet recording apparatus according to another embodiment of the present invention.

### DESCRIPTION OF EMBODIMENTS

### First Embodiment

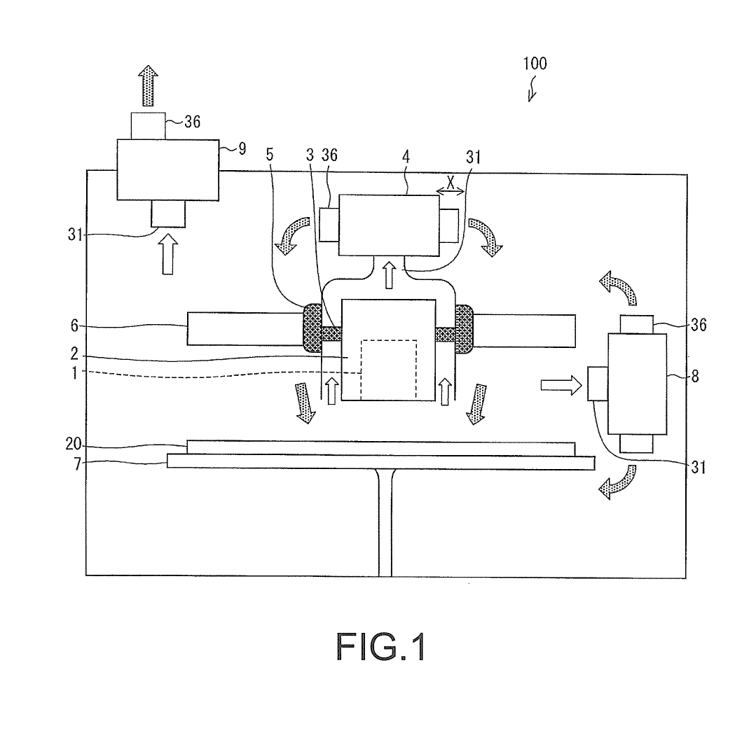

Hereinafter, an embodiment of the present invention will be described in detail with reference to FIG. 1. FIG. 1 is a drawing illustrating an inkjet recording apparatus of this embodiment.

### [Inkjet Recording Apparatus 100]

The inkjet recording apparatus of the present invention is used for ejecting ink containing a volatile organic compound (VOC) (hereinafter, also referred to as “ink”) onto a recording medium. The inkjet recording apparatus of the present invention is configured to perform printing on the recording medium by moving positions of a head and the recording medium relatively to each other.

As illustrated in FIG. 1, an inkjet recording apparatus 100 according to this embodiment includes a carriage 2, a guide mechanism 6, a platen 7, a circulation decomposition device 8, and an exhaust decomposition device 9. The inkjet recording apparatus 100 is an inkjet printer of a serial head type configured to perform printing on a medium 20 in a state in which the direction of movement of a head 1 and the direction of movement of the medium 20 are orthogonal to each other.

### [Carriage 2]

The carriage 2 ejects ink containing the volatile organic compound from the head 1 to the medium (recording medium) 20. The carriage 2 draws a desired image on the medium 20 while sweeping along the guide mechanism 6 in a direction indicated by an arrow X in FIG. 1. The carriage 2 also includes an adsorption member (adsorption means) 3, a decomposition device (decomposition means) 4, and a media drying fan 5.

### (Medium 20)

The recording medium is a thing to which ink ejected from the head is adhered. The recording medium may be determined depending on the object, and for example, a plate-shaped member, a sheet-shaped member, and the like are exemplified.

In this embodiment, the medium 20 is placed on the platen 7. The platen 7 is provided with a heater for drying the image drawn on the medium 20.

### (Ink)

The ink to be used in the present invention is not limited as long as the ink contains solvent, and, for example, aqueous ink, solvent ink, heat-cured ink, UV-cured ink, and the like are exemplified. In this embodiment, the ink exemplified above is ejected from the head 1 onto the medium 20, and is heated on the platen 7, whereby water, the volatile organic compound, and the like contained in the solvent are volatilized.

### <Volatile Organic Compound>

The volatile organic compound is organochemical which volatilizes easily into atmosphere at ordinary temperatures and pressures, and is an organic solvent used in ink such as aqueous ink, solvent ink, heat-cured ink, UV-cured ink, and the like. Examples of the volatile organic compound include, for example, hexane, heptane, octane, isooctane, cyclohexane, benzene, toluene, o-xylene, m-xylene, p-xylene, ethyl benzene contained in hydrocarbon system solvent and also include organochemical such as dichloromethane, fluorocarbons, propylene glycol monomethyl ether, propyl acetate, propylene glycol monomethyl ether acetate, ethylene glycol, tetralin, N-methyl-2-pyrrolidone and ethylene glycol monomethylether.

### (Adsorption Member 3)

The adsorption means provided on the inkjet recording apparatus of the present invention is configured to adsorb the mist ink generated when the ink is ejected from the head. Normally, all of the ink ejected from the head does not adhere to the recording medium, and the mist ink generates in the inkjet recording apparatus. When the volatile organic compound contained in the ink volatilizes, the volatilized compound is mixed with the mist ink generating when the ink is ejected from the head in the inkjet recording apparatus.

In this embodiment, the adsorption member 3 is provided on the carriage 2 and, as illustrated in FIG. 1, the volatile organic compound can be introduced into the decomposition device 4 only after the adsorption member 3 has passed through the mixture of the volatile organic compound and the mist ink. When the adsorption member 3 is passed through the mixture, the mist ink is adsorbed. Therefore, introduction of the mist ink into the decomposition device 4 is prevented, and only the volatile organic compound can be introduced into the decomposition device 4. The volatile organic compound is introduced into the decomposition device 4 in a state of being mixed with air (oxygen) used for decomposing the volatile organic compound when being introduced into the decomposition device 4.

As illustrated in FIG. 1, the adsorption member 3 can suitably prevent the mist ink from being introduced into the decomposition device 4 by being provided on a flow channel for introducing the volatile organic compound into the decomposition device 4. In addition, with this structure, collection of the mist ink by the adsorption member 3 and introduction of the volatile organic compound into the decomposition device 4 can be performed commonly by a single airflow generating apparatus (fan 32), so that the inkjet recording apparatus can be configured to have a further compact profile.

Adsorption means provided on the inkjet recording apparatus of the present invention is not limited as long as adsorption of the mist ink is possible, and for example, a porous filter, activated coal, non-woven fabric are exemplified. A twilled dutch weave filter or a fiber filter having a coarseness corresponding to the diameter of the mist ink is preferable.

### (Decomposition Device 4)

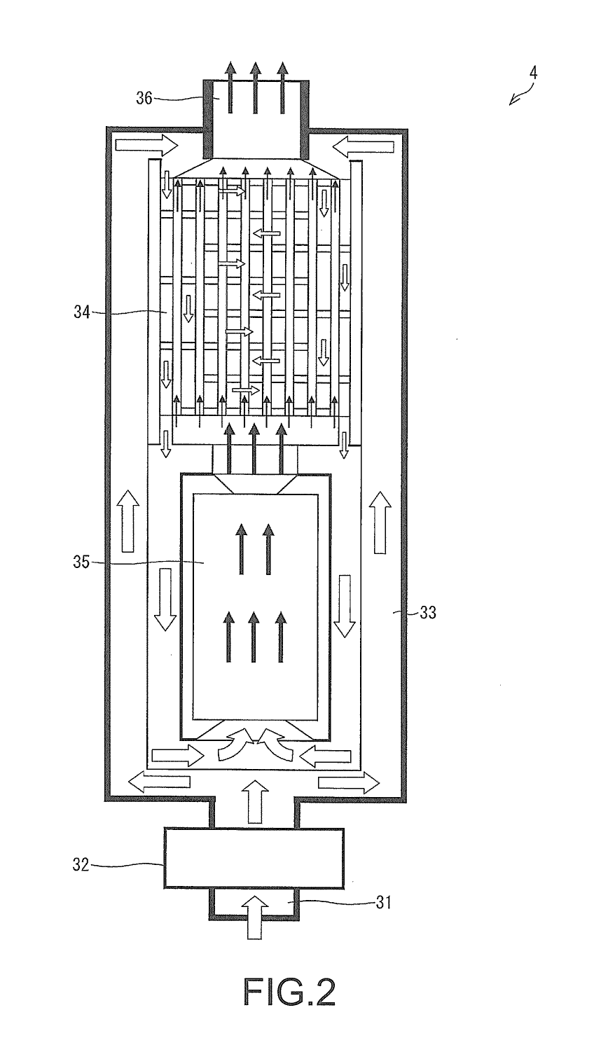

The decomposition means provided on the inkjet recording apparatus of the present invention is provided on the carriage and configured to decompose the volatile organic compound. Hereinafter, one embodiment of the decomposition device 4 will be explained with reference to FIG. 1 and FIG. 2. FIG. 2 is a drawing illustrating the decomposition means provided on the inkjet recording apparatus according to one embodiment of the present invention.

As illustrated in FIG. 2, the decomposition device 4 is provided with an introduction port 31, the fan 32, an introduction tube 33, a heat exchanging unit 34, a decomposition unit 35, and a discharging port 36. The decomposition device 4 is provided on the carriage 2, but in addition, a required number of decomposition means having the same configuration as the decomposition device 4 may be provided in the inkjet recording apparatus 100.

The decomposition device 4 needs at least to be capable of decomposing the volatile organic compound in the mist ink generated when the ink is ejected from the head 1. In other words, as long as the volatile organic compound in the mist ink is decomposed, other volatile organic substances generating from other positions may also be decomposed. For example, the decomposition device 4 may be capable of also suitably decomposing the volatile organic substance vaporized from ink landed on the medium (recording medium). In this embodiment, the decomposition device 4 is located at a position at which the volatile organic substance volatilized from the ink landed on the medium can suitably be decomposed. In other words, the decomposition device 4 is configured to decompose not only the volatile organic compound in the mist ink, but also the volatile organic substance volatilized from the ink landed on the medium.

For example, a position of the decomposition device 4 provided on the carriage 2 is, preferably a center portion of the carriage 2, and more preferably, above the guide mechanism 6. By providing the decomposition device 4 at this position, the carriage 2 is prevented from becoming unstable when sweeping is performed with the carriage 2 along the guide mechanism 6. Since the guide mechanism 6 is capable of supporting the decomposition device 4, an influence of a load of the decomposition device 4 on inkjet recording accuracy may be reduced. Therefore, an increase in mass of the guide mechanism 6 or an increase in size of the inkjet recording apparatus 100 in order to improve the strength of the guide mechanism 6 for reducing the influence of the load may be prevented.

The introduction port 31 is for introducing the volatile organic compound into the decomposition device 4. Also, as illustrated in FIG. 1, if the adsorption member 3 is provided, the mist ink is not supplied to the introduction port 31. Therefore, only the volatile organic compound can be introduced into the decomposition device 4, and hence lowering of the decomposition function of the decomposition device 4 due to adhesion of the mist ink into the decomposition device 4 may be prevented.

The fan 32 generates an air flow, introduces the mist ink and the volatile organic compound into a flow channel, and introduces the volatile organic compound introduced from the interior of the flow channel into the introduction port 31 to the introduction tube 33.

The introduction tube 33 is a tube for introducing the volatile organic compound from the introduction port 31 to the heat exchanging unit 34, and is provided outside the decomposition unit 35 and the heat exchanging unit 34.

The heat exchanging unit 34 is configured to introduce gas containing the volatile organic compound (mixed gas containing the volatile organic compound and air) to the decomposition unit 35, and introduce exhaust gas having heat generating when the volatile organic compound is decomposed in the decomposition unit 35 to the discharging port 36. The exhaust gas passes through the interior of a pipe tube formed of copper, SUS, aluminum, iron, or the like. The heat exchanging unit 34 is formed so as to supply heat from the exhaust gas to the gas containing the volatile organic compound.

The decomposition unit 35 is configured to decompose the volatile organic compound supplied from the heat exchanging unit 34 and generate the exhaust gas. The decomposition unit provided on the inkjet recording apparatus of the present invention may be provided with a heating means such as a heater in order to accelerate decomposition reaction of the volatile organic compound.

The decomposition of the volatile organic compound may be achieved by a given decomposition method. However, decomposition of the volatile organic compound is preferably performed by oxidation decomposition processing method. When removing the volatile organic compound by using adsorption method, replacement of the adsorbing material is required, and it is difficult to obtain a removing performance stable for a long time. When condensing the volatile organic compound by using cold condensation method, cooling device is provided, and in addition a method of removing the volatile organic compound is required, so that the size of the apparatus is increased. In contrast, by employing the oxidation decomposition processing method, a stable volatile organic compound removal performance can be maintained for a long term in comparison with other decomposition methods. As a detailed example of the oxidation decomposition processing method, a catalytic system, a direct burning system and the like using a burner, a heating wire or the like are exemplified.

As an oxidation decomposition processing method, for example, a method disclosed in JP-A-2005-139440 (published Jun. 2, 2005, U.S. Pat. No. 4,517,146) may be used.

In the case where oxide semiconductor formed of chrome oxide, nickel oxide, iron oxide, titanium oxide or the like is used as a catalyst for decomposition of the volatile organic compound in the decomposition unit 35, it is preferably to heat and thermally activate the catalyst with a heater or the like so that the temperature of the catalyst falls within a range from 200° C. to 500° C. inclusive. Accordingly, the volatile organic compound can be decomposed efficiently by the decomposition unit 35.

The volatile organic compound is decomposed into water vapor, carbon dioxide at the decomposition unit 35, and these gas are discharged from the discharging port 36 as the exhaust gas via the heat exchanging unit 34. Heat is generated when decomposing the volatile organic compound into the exhaust gas, and the exhaust gas has a heat generated when the volatile organic compound is decomposed. Here, heat generating when the volatile organic compound is decomposed includes heat generation caused by decomposing the compound, and heat generating from the heating means such as the heater.

The exhaust gas passing through the heat exchanging unit 34 has heat generating when the volatile organic compound is decomposed, whereby the heat is supplied from the exhaust gas to the gas containing the volatile organic compound in the heat exchanging unit 34. Then, the gas containing the volatile organic compound to which the heat is supplied is introduced to the decomposition unit 35, lowering of the temperature in the decomposition unit 35 is restrained. Therefore, even in the case where the heating means such as the heater is provided on the decomposition unit 35 for accelerating the decomposition of the volatile organic compound, required heating amount may be reduced.

The temperature of the exhaust gas can be lowered by heat-exchange between the exhaust gas and the gas containing the volatile organic compound. Therefore, damage, deformation and the like of the inkjet recording apparatus caused by the high-temperature exhaust gas being exhausted is restrained. In order to fix the temperatures of the exhaust gas and the gas containing the volatile organic compound within an adequate range by the heat exchanging unit 34, a configuration of the heat exchanging unit 34 may be changed to adjust the calorific power transferred from the exhaust gas to the gas containing the volatile organic compound as needed. For example, the material of the pipe tube in the heat exchanging unit 34, the number of times of contact between the pipe tube and the gas containing the volatile organic compound, the distance of contact thereof, and the like may be adjusted as needed.

Also, since the introduction tube 33 is provided further outside than the decomposition unit 35 and the heat exchanging unit 34, heat generating when the volatile organic compound is decomposed can be absorbed by the gas containing the volatile organic compound and passing through the introduction tube 33. Also, since the heat generating in the decomposition unit 35 and the heat exchanging unit 34 is further restrained from being transferred to the carriage 2, damage of the carriage 2 by heat can be restrained.

The introduction tube provided on the inkjet recording apparatus of the present invention is preferably formed so as to cover the decomposition unit and the heat exchanging unit. Accordingly, the gas containing the volatile organic compound in the introduction tube can absorb heat discharging from the decomposition unit and the heat exchanging unit, whereby improvement of the decomposition efficiency of the compound can be achieved. Also, since the high-temperature portion is not exposed, the inkjet recording apparatus superior in safety, durability and the like is achieved.

The discharging port 36 is configured to exhaust the exhaust gas out of the decomposition device 4.

As descried above, since the carriage 2 has the decomposition device 4 configured to decompose the volatile organic compound, the volatile organic compound having a high concentration before the volatile organic compound disperses widely in the interior of the inkjet recording apparatus 100 can be collected and efficiently decomposed. Therefore, treatment of a large amount of air in the inkjet recording apparatus 100 is not necessary, and electric power consumed when decomposing the volatile organic compound may be small.

Since the carriage 2 is provided with the decomposition device 4, the inkjet recording apparatus 100 can be configured to have a further compact profile. The present invention may be applied to inkjet printer (inkjet recording apparatus) of various type. For example, a decomposition effect of the volatile organic compound can be obtained even with a flat-bed type inkjet printer in which the cavity for covering the recording medium cannot be provided.

Furthermore, as illustrated in FIG. 1, the platen 7 on which the medium 20 is placed and the guide mechanism 6 can face each other in a wide range. Therefore, the ratio of an amount of generation of the volatile organic compound within a sweeping range of the carriage 2 with respect to the amount of generation of the volatile organic compound generating in the inkjet recording apparatus 100 is large. Therefore, the volatile organic compound can be decomposed efficiently.

The medium 20 is dried by the exhaust gas exhausted from the discharging port 36 blown to the medium 20 by the media drying fan 5 mounted on the carriage 2.

The media drying fan 5 is not limited as long as the configuration allows the exhaust gas exhausted from the discharging port 36 to be blown to the medium 20, and may be installed at an arbitrary position in the inkjet recording apparatus 100 instead of the carriage 2. The exhaust gas may be blown directly to the medium 20, but may also be blown into the platen 7 and utilized as a heater.

As describe above, the exhaust gas having heat is generated by decomposing the volatile organic compound by the decomposition device 4. Since the exhaust gas is exhausted from the decomposition device 4 via the discharging port 36 and is blown to the medium 20, and is dried, the medium 20 can be dried efficiently.

### (Circulation Decomposition Device 8)

As the decomposition means having the same configuration as the decomposition device 4, the circulation decomposition device 8 may be provided in the inkjet recording apparatus 100. As illustrated in FIG. 1, the circulation decomposition device 8 is provided at an end portion of the medium 20 and the guide mechanism 6, and the volatile organic compound which is not decomposed by the decomposition device 4 is collected and decomposed. Then, the exhaust gas after the decomposition is exhausted to an upper side of the guide mechanism 6 and a lower side of the platen 7 from the discharging port 36.

The exhaust gas exhausted to the upper side of the guide mechanism 6 has heat like the exhaust gas exhausted from the decomposition device 4 described above. Therefore, the exhaust gas being blown to the medium 20 by the media drying fan 5 contributes to drying of the medium 20.

The exhaust gas exhausted to the lower side of the platen 7 has heat like the exhaust gas exhausted from the decomposition device 4 described above. Therefore, the exhaust gas can be blown into the platen 7 so that the platen 7 can be used as a heater.

The circulation decomposition device 8 may be provided with a flow channel for introducing the volatile organic compound into the introduction port 31, and is provided with the adsorption means configured to adsorb the mist ink thereon. Accordingly, the mist ink is prevented from being introduced into the circulation decomposition device 8.

### (Exhaust Decomposition Device 9)

Alternatively, the exhaust decomposition device 9 may be provided in the inkjet recording apparatus 100 as a decomposition means having the same configuration as the decomposition device 4. As illustrated in FIG. 1, the exhaust decomposition device 9 is exposed to the outside of the inkjet recording apparatus 100, and is configured to collect and decompose the volatile organic compound, which has not been decomposed by the decomposition device 4 or the circulation decomposition device 8. Then, the exhaust decomposition device 9 exhausts the exhaust gas after decomposed from the discharging port 36.

The exhaust decomposition device 9 may be provided with a flow channel for introducing the volatile organic compound into the introduction port 31, and is provided with the adsorption means configured to adsorb the mist ink thereon. Accordingly, the mist ink is prevented from being introduced into the exhaust decomposition device 9.

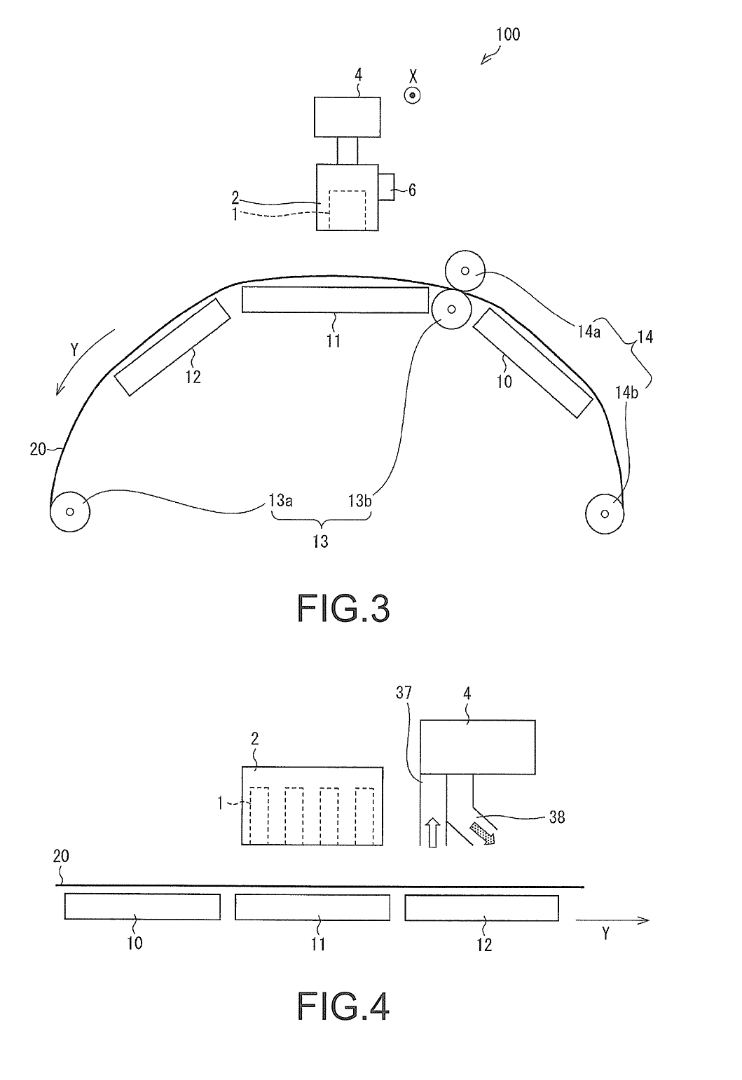

Hereinafter, a positional relationship of the respective members of the inkjet recording apparatus 100 according to the embodiment will be described with reference to FIG. 3. FIG. 3 is a drawing illustrating the inkjet recording apparatus according to an embodiment of the present invention. In FIG. 3, the respective configurations are simplified, and components such as the media drying fan 5, the circulation decomposition device 8, and the like are omitted.

As illustrated in FIG. 3, the inkjet recording apparatus 100 includes the carriage 2, the media drying fan 5, the guide mechanism 6, a pre-platen 10, a main platen 11 (the platen 7), an after-platen 12, a drive unit 13, and a driven unit 14.

The inkjet recording apparatus 100 ejects ink containing the volatile organic compound to the medium 20 while sweeping in the direction indicated by an arrow X in an area where the main platen 11 and the guide mechanism 6 face each other.

All of the pre-platen 10, the main platen 11, and the after-platen 12 are beds for placing the medium 20. All of the pre-platen 10, the main platen 11, and the after-platen 12 can heat the medium 20 placed thereon.

The drive unit 13 includes two drive rollers 13a, 13b, which move the medium 20 in the direction indicated by an arrow Y in FIG. 3 by being driven with respect to each other. The driven unit 14 includes two driven rollers 14a, 14b.

By driving of the drive rollers 13a, 13b, the medium 20 wound around the driven roller 14b is conveyed in the direction indicated by an arrow Y and is wound around the drive roller 13a. The driven roller 14a forms a pair with the drive roller 13b by the intermediary of the medium 20, and is provided to help the conveyance of the medium 20.

In the inkjet recording apparatus 100 as illustrated in FIG. 3, the ink containing the volatile organic compound is ejected from heads 1 onto the medium 20 placed on the main platen 11, sweeps in the direction indicated by an arrow X, and after the eject of the ink within a desired range has terminated, the drive unit 13 is driven and the medium 20 having the ink ejected thereon is moved toward the after-platen 12.

The ink ejected on the medium 20 is heated firstly on the main platen 11, most part of the volatile organic compound contained in the ink is vaporized, and a small amount of the volatile organic compound is vaporized on the after-platen 12. Here, the carriage 2 provided with the decomposition device 4 sweeps on the main platen 11 along the guide mechanism 6, and hence the generated volatile organic compound can be efficiently decomposed.

### Second Embodiment

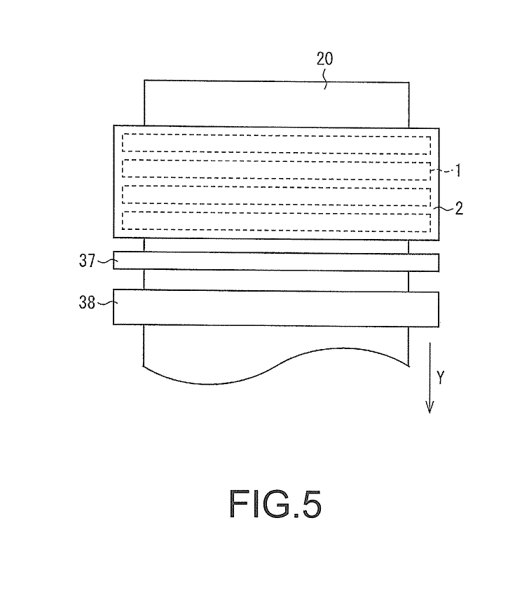

Hereinafter, another embodiment of the present invention will be described with reference to FIGS. 4 and 5. FIG. 4 is a drawing illustrating the inkjet recording apparatus according to another embodiment of the present invention, and FIG. 5 is a top view of the inkjet recording apparatus illustrated in another embodiment of the present invention. The same members as the first embodiment are denoted by the same reference numerals, and description thereof is omitted.

As illustrated in FIGS. 4 and 5, the inkjet recording apparatus according to this embodiment is an inkjet printer of a line-head type configured to move the medium 20 in a state in which the heads 1 are fixed and perform printing on the medium 20.

The heads 1 and the carriage 2 face the main platen 11, and a plurality of heads 1 eject ink on the medium 20 on the main platen 11. After the printing on the medium 20 has terminated, the medium 20 is moved in the direction indicated by an arrow Y, and the ink is ejected in another area of the medium 20, and printing is started as illustrated in FIG. 4.

In the inkjet recording apparatus according to this embodiment, the decomposition device 4 is provided on the side where the medium 20 after the printing is moved when viewed from the heads 1. The decomposition device 4 includes the suction port 37 and a blow-out port 38. The decomposition device 4 may be provided on a side surface of the carriage 2, or may be provided separately from the carriage 2.

The suction port 37 sucks the volatile organic compound and the mist ink. Therefore, the decomposition device 4 sucks the mist ink generated when the ink is ejected from the heads 1 and the volatile organic compound volatilized from the medium 20 on the main platen 11 and the after-platen 12 via the suction port 37.

The suction port 37 is provided with an adsorption means (not illustrated) configured to adsorb the mist ink. Therefore, when the adsorption means described above is passed through the volatile organic compound and the mixture containing the mist ink, the mist ink is adsorbed. Therefore, only the volatile organic compound can be introduced into the decomposition means, and hence lowering of decomposition function of the decomposition means due to the introduction of the mist ink into the decomposition means is prevented.

After the printing on the medium 20 has terminated, the medium 20 is moved toward the after-platen 12 provided with the decomposition device 4. Then, the decomposition device 4 is allowed to collect and decompose the volatile organic compound volatilized from the medium 20 after the printing efficiently.

The decomposition device 4 is located so as to be capable of decomposing the volatile organic compound in the mist ink generated when the ink is ejected from the heads 1, and hence is located in the vicinity of the heads 1. The volatile organic compound with high concentration before the volatile organic compound is dispersed widely within the inkjet recording apparatus can be collected and efficiently decomposed, so that a configuration of the apparatus having a compact profile is achieved.

In the case where an airflow generating apparatus is provided at the suction port, the airflow generating apparatus can be commonly used for collection of the mist ink by the adsorption means and introduction of the volatile organic compound to the decomposition means, so that the inkjet recording apparatus can be configured to have a further compact profile.

The blow-out port 38 is configured to exhaust the exhaust gas generated from the volatile organic compound decomposed by the decomposition unit 35 of the decomposition device 4, and flows the exhaust gas onto the medium 20 on the after-platen 12. By blowing the exhaust gas having heat onto the medium 20, the medium 20 can be dried efficiently.

In this embodiment, a configuration in which the decomposition device 4 is provided only on the side to which the medium 20 after the printing moves has been described. However, the invention is not limited thereto. For example, the decomposition means may be provided also on the pre-platen 10 side where the medium 20 before printing is located. Accordingly, the volatile organic compound generating during the printing on the medium 20 can be decomposed further efficiently. In the same manner as the first embodiment, the circulation decomposition device or the exhaust decomposition device may be provided in the inkjet recording apparatus.

### [Remarks]

The inkjet recording apparatus 100 according to an embodiment of the present invention is the inkjet recording apparatus 100 including the heads 1 configured to eject the ink containing the volatile organic compound onto the medium 20, and configured to perform printing on the medium 20 by moving the positions of the heads and the medium 20 relatively, and includes the decomposition device 4 configured to at least decompose the volatile organic compound in the mist ink generated when the ink is ejected from the heads 1.

Since the ink contains the volatile organic compound, when the ink is ejected from the heads 1 onto the medium 20, the volatile organic compound volatilizes. Also, when the ink is ejected from the heads 1, the mist ink containing the volatile organic compound is generated. Here, the decomposition device 4 decomposes the volatile organic compound in the mist ink generated when the ink is ejected from the heads 1 in addition to the volatile organic compound vaporized from the ink ejected onto the medium 20. Therefore, the volatile organic compound with high concentration before the volatile organic compound is dispersed widely within the inkjet recording apparatus 100 can be collected and efficiently decomposed. Therefore, treatment of a large amount of air in the inkjet recording apparatus 100 is not necessary, and electric power consumed when decomposing the volatile organic compound may be small.

The decomposition device 4 is located so as to be capable of decomposing a volatile substance in the mist ink generated when the ink is ejected, and hence is located in the vicinity of the heads 1. Therefore, the apparatus may be configured to have a compact profile.

In the inkjet recording apparatus 100, the carriage 2 having the heads 1 is provided, and the carriage 2 sweeps on the medium 20 and is provided with the decomposition device 4.

Since the carriage 2 configured to sweep on the medium 20 has the decomposition device 4 configured to decompose the volatile organic compound, the volatile organic compound having a high concentration before the volatile organic compound disperses widely in the interior of the inkjet recording apparatus 100 can be collected and efficiently decomposed.

Since the carriage 2 is provided with the decomposition device 4, the inkjet recording apparatus 100 can be configured to have a further compact profile.

Preferably, in the inkjet recording apparatus 100, the carriage 2 further includes the adsorption member 3 configured to adsorb the mist ink generated when the ink is ejected from the heads 1, and the adsorption member 3 is passed through the volatile organic compound and the mist ink, and then the decomposition device 4 decomposes the volatile organic compound.

When the volatile organic compound is vaporized, the volatilized compound is mixed with the mist ink generated when the ink is ejected from the heads 1 within the inkjet recording apparatus 100. When the adsorption member 3 is passed through the mixture, the mist ink is adsorbed. Therefore, only the volatile organic compound can be introduced into the decomposition device 4, and hence lowering of decomposition function of the decomposition device 4 due to the introduction of the mist ink into the decomposition device 4 is prevented.

In the case where an airflow generating apparatus such as the fan 32 is provided, the airflow generating apparatus can be commonly used for collection of the mist ink by the adsorption member 3 and introduction of the volatile organic compound to the decomposition device 4, so that the inkjet recording apparatus 100 can be configured to have a further compact profile.

In the inkjet recording apparatus 100, the heads 1 are fixed and the printing on the medium 20 is performed by moving the medium 20, and the decomposition device 4 is provided on the side when viewed from the heads 1 to which the medium 20 after printing moves.

After the printing on the medium 20 has terminated, the medium 20 is moved toward the side where the decomposition device 4 is provided. Therefore, the decomposition device 4 is allowed to collect and decompose the volatile organic compound volatilized from the medium 20 after the printing efficiently.

Also, in the inkjet recording apparatus according to the second embodiment, the decomposition device 4 includes the suction port 37 configured to suck the volatile organic compound and the mist ink, the suction port 37 includes adsorption means configured to adsorb the mist ink, and the adsorption means is passed through the volatile organic compound and the mist ink, and then the decomposition device 4 decomposes the volatile organic compound.

When the volatile organic compound contained in the ink is vaporized, the vaporized compound is mixed with the mist ink generated when the ink is ejected from the heads 1 within the inkjet recording apparatus 100. Then, when the mixture is sucked into the interior of the suction port 37 and the adsorption means is passed through the mixture, the mist ink is adsorbed. Therefore, only the volatile organic compound can be introduced into the decomposition device 4, and hence lowering of decomposition function of the decomposition device 4 due to the introduction of the mist ink into the decomposition device 4 is prevented.

In the inkjet recording apparatus 100 of the present invention, the decomposition device 4 includes the introduction port 31 configured to introduce the volatile organic compound, and the discharging port 36 configured to exhaust the exhaust gas having heat generating when the volatile organic compound is decomposed, and the medium 20 is dried by blowing the exhaust gas exhausted from the discharging port 36 to the medium 20.

By decomposing the volatile organic compound, the exhaust gas having heat is generated. The exhaust gas is exhausted from the decomposition device 4 via the discharging port 36, and is blown to the medium 20. Accordingly, the exhaust gas having heat is blown to the medium 20, so that the medium 20 can be dried efficiently.

Also, in the inkjet recording apparatus 100, the decomposition device 4 includes a decomposition unit 35 configured to decompose the volatile organic compound and generate the exhaust gas, and a heat exchanging unit 34 configured to introduce the volatile organic compound to the decomposition unit 35 and introducing the exhaust gas from the decomposition unit 35 to the discharging port 36, and the heat exchanging unit 34 supplies heat from the exhaust gas to the volatile organic compound.

In the heat exchanging unit 34, the exhaust gas has heat generating when the volatile organic compound is decomposed, and supplies the heat from the exhaust gas to gas containing the volatile organic compound (for example, mixed gas of volatile organic compound and air). Then, the gas containing the volatile organic compound to which the heat is supplied is introduced to the decomposition unit 35, lowering of the temperature in the decomposition unit 35 is restrained.

Also, in the inkjet recording apparatus 100, the decomposition device 4 is provided with the introduction tube 33 configured to introduce the volatile organic compound from the introduction port 31 into the decomposition unit 35, and the introduction tube 33 is provided further outside than the decomposition unit 35 and the heat exchanging unit 34.

Since the introduction tube 33 is provided further outside than the decomposition unit 35 and the heat exchanging unit 34, heat generating when the volatile organic compound is decomposed can be absorbed by the gas containing the volatile organic compound and passing through the introduction tube 33. Also, transfer of the heat generating in the decomposition unit 35 and the heat exchanging unit 34 to the carriage 2 is further restrained, and hence damage of the carriage 2 by the heat can be restrained.

Preferably, in the inkjet recording apparatus 100, the decomposition device 4 decomposes the volatile organic compound by oxidation decomposition processing method.

By employing the oxidation decomposition processing method, the inkjet recording apparatus 100 can be formed into a compact profile, and a stable volatile organic compound removal performance can be maintained for a long term in comparison with other decomposition methods. As a detailed example of the oxidation decomposition processing method, a catalytic system, a direct burning system and the like using a burner, a heating wire, or the like are exemplified.

The present invention is not limited to the respective embodiments described above, may be modified in various ways within a scope described in claims, and embodiments obtained by combining technical means disclosed in different embodiments as needed are also included in the technical scope of the present invention.

### INDUSTRIAL APPLICABILITY

The present invention may be utilized in inkjet print.

1. An inkjet recording apparatus comprising:
a head configured to eject ink containing volatile organic compound on a recording medium; and being configured to perform printing on the recording medium by relatively moving positions of the head and the recording medium,
characterized by being provided with a decomposition means configured to at least decompose the volatile organic compound in mist ink generated when ink is ejected from the head.

2. The inkjet recording apparatus according to claim 1, comprising a carriage having the head, wherein the carriage sweeps on the recording medium, and
the carriage includes the decomposition means.

3. The inkjet recording apparatus according to claim 2, wherein the carriage further includes an adsorption means configured to adsorb the mist ink, and the adsorption means is passed through the volatile organic compound and the mist ink, and then the decomposition means decomposes the volatile organic compound.

4. The inkjet recording apparatus according to claim 1, wherein the head is fixed, and the inkjet recording apparatus is configured to move the recording medium to perform printing on the recording medium, and the decomposition means is provided on a side where the recording medium after printing is moved when viewed from the head.

5. The inkjet recording apparatus according to claim 4, wherein the decomposition means includes a suction port configured to suck the volatile organic compound and the mist ink, the suction port includes an adsorption means configured to adsorb the mist ink, and the adsorption means is passed through the volatile organic compound and the mist ink, and then the decomposition means decomposes the volatile organic compound.

6. The inkjet recording apparatus according to claim 3, wherein the decomposition means includes an introduction port configured to introduce the volatile organic compound, and a discharging port configured to exhaust an exhaust gas having heat generating when the volatile organic compound is decomposed, and the recording medium is dried by blowing the exhaust gas exhausted from the discharging port to the recording medium.

7. The inkjet recording apparatus according to claim 6, wherein the decomposition means includes a decomposition unit configured to decompose the volatile organic compound and generate the exhaust gas, and a heat exchanging unit configured to introduce the volatile organic compound to the decomposition unit and introduce the exhaust gas from the decomposition unit to the discharging port, and the heat exchanging unit supplies heat from the exhaust gas to the volatile organic compound.

8. The inkjet recording apparatus according to claim 7, wherein the decomposition means includes an introduction tube for introducing the volatile organic compound to the decomposition unit from the introduction port, and the introduction tube is provided further outside than the decomposition unit and the heat exchanging unit.

9. The inkjet recording apparatus according to claim 1, wherein the decomposition means decomposes the volatile organic compound by oxidation decomposition processing method.

10. The inkjet recording apparatus according to claim 5, wherein the decomposition means includes an introduction port configured to introduce the volatile organic compound, and a discharging port configured to exhaust an exhaust gas having heat generating when the volatile organic compound is decomposed, and the recording medium is dried by blowing the exhaust gas exhausted from the discharging port to the recording medium.
